(19) United States
(12) Patent Application Publication
(10) Pub. No.: US 2009/0144118 A1
(43) Pub. Date: Jun. 4, 2009

(54) METHOD FOR MANAGING A TRANSITION PERIOD DURING REPLACEMENT OF SOFTWARE OR BUSINESS PROCESS

(75) Inventors: Nurit Zelig, Bnei Brak (IL); Yehezkeel Ben Artzi, Ra'anana (IL)

Correspondence Address: BROWDY AND NEIMARK, P.L.L.C.;624 NINTH STREET, NW, SUITE 300, WASHINGTON, DC, 20001-5303, US

(73) Assignee: G.P.V. PROCESS ANALYSIS & SOLUTIONS LTD., Ra'anana (IL)

(21) Appl. No.: 12/327,225

(22) Filed: Dec. 3, 2008

(30) Foreign Application Priority Data
Dec. 3, 2007 (IL) 187835

(51) Int. Cl. G06Q 10/00; G06F 9/44; G05B 19/418; G06Q 90/00

(52) U.S. Cl. 705/8; 705/7

(57) ABSTRACT

A method for managing a transition period during which a software application is replaced in a commercial organization is provided. The method comprises the steps of: providing a transition plan for execution during the transition period; providing a contingency plan to allow for contingency responses in case of unexpected events occurring during the execution of said transition plan; confirming readiness of at least part of the transition plan and the contingency plan; and carrying out the transition plan.

### FIELD OF THE INVENTION

The present invention relates to a method for reducing risks, and in particular, to a method of implementing risk management during a process of replacing software application(s) and/or business process(es)in organizations.

### BACKGROUND OF THE INVENTION

The ever-growing reliance of today's companies on various IT applications for their entire operation has turned these companies exposed to critical business mal-functioning at times when there is a need to upgrade one or more of these applications. Not only that all of the commercial data of such a company is associated with the old applications, but also these applications might be interconnected, and a replacement of one application may result in catastrophic results for users of other applications which had been retrieving data from the old application for use in their applications. At the same time, there is a growing rate at which these applications have to be replaced with new ones, ones that are more powerful, offer more features to the user and/or to the organization etc. It is therefore very clear that such organizations become increasingly exposed to failures that might occur during transition periods, where the organization shifts from one software application to another. Similar problems arise when a company decides to replace/modify its business process(es).

In addition, such replacement projects are very difficult to manage efficiently. This is due partly to the fact that presently, the organization, planning, implementing and tracking of such replacement projects is not a one well thought process and there is too much reliance on ad-hock amendments of things to be carried out when the process is already under way. On the other hand, the consequences of a failure in the process cannot be taken lightly and they might range from a temporary paralysis of part of the organization activity, up to even, in extreme cases, the collapse of a company that is not able to recover everything that has been lost while taking such a step. Other drawbacks of a lack of end-to-end vision of the project might be: loosely defined methods and practices and inefficient use of staff time, and computer systems resources.

Such a transition process is very complex because the problems as well as personnel involved turn the process, whether the change is big or small, into a multi dimensional process, involving modules that are likely to effect the operation of other modules that are not being replaced, and would involve personnel from different layers, divisions, etc. of the organization, some of which may even not be the users of the application being replaced, but only users of applications that apply to one extend or another, certain outputs that should have been received from the replaced application by the applications they are using.

The complexity of managing such a process is even higher due in large part to the fact that presently, the organization, planning, implementing and tracking of such replacement projects is a manual process without the benefit of a central data warehouse to track project related information. This in turn results in an increased risk of exposure for damage claims, losing clients, opening opportunities for fraudulent activities by staff or others, etc. These issues ultimately result in increased costs. Other drawbacks of organizing, planning, implementing and tracking such projects via manual means include non-centralized information, limited or non-existent daily, monthly and annual audit data and controls, a lack of end-to-end vision of the project, loosely defined methods and practices which vary significantly from one community to the other, an inefficient use of staff time, etc.

In view of the foregoing considerations, there is a need for a well defined method that will at least reduce the business risks to which organizations might be subjected to during such sensitive periods of transition.

### SUMMARY OF THE INVENTION

It is an object of the present invention to provide a method to reduce the risks to which organizations are subjected while undergoing transition which require replacing software application and/or a business process.

It is another object of the invention to provide a method to assist organizations in their preparation for assessing, tracking, and implementing replacement projects of software and/or business process.

It is still another object of the present invention to allow identifying critical possible business events that may occur during the transition period and to enable providing an adequate response thereto.

Other objects of the present invention will become more apparent from the following detailed description of the invention taken together with the accompanying examples and appended claims.

In accordance with a first embodiment of the present invention there is provided a method for use by an organization for managing a transition period during which at least one software application is changed (e.g. modified and/or replaced and/or updated), the method comprises the steps of:
(i) providing a plan for the transition period;
(ii) providing a plan for a contingency response for failures that might occur during the execution of the transition plan and preferably also for cases of unexpected business events;
(iii) confirming readiness of at least part of the provided plans; and
(iv) managing the transition.

The term “software application” as used herein and throughout the specification and claims, should be understood to encompass both, certain software that is a candidate for change/replacement whether by a newer version or by a completely different software as well as to encompass business process that is a candidate for a change/replacement.

Also, although the specification and claims are described in connection with the change of the software application, it should be appreciated that the present application also encompasses effecting a change in the business process of a company in accordance with the processes described herein, mutates mutandis.

According to a preferred embodiment of the invention, in preparing the plans for the transition period and/or for the contingency response one or more of the following objectives are selected so that the plan that will be provided shall conform to these one or more objectives.
a) minimizing business interruptions throughout the change;
b) minimizing disruptions for customers, suppliers and employees;
c) participation of customers, suppliers and business partners at the preparations phase;
d) identifying critical company's activities;
e) involving inner company's users as part of a “buy in” process;
f) making management aware of business risks;
g) minimizing “go live” process potential faults;
h) designating user responsibilities;
i) validating the plans;
j) confirming company's preparations readiness;
k) supervising the execution of the transition plan; and
l) controlling risk management.

In the plan for the transition period, a certain period should be designated throughout which the company's operational systems will not be used for providing business responses. Any use of the operational systems during this designated period, will immediately entail stopping the execution of the transition plan and will lead to a transition failure. Therefore, according to another embodiment of the invention, the method provided comprises a step of identifying maximum critical possible business events that might occur during the transition period and anticipating one or more responses to each such an event independent of the operational system(s), i.e. under the assumption the operational system(s) or part of them is/are down. Preferably, the one or more anticipated responses further comprise a step of reporting various activities that have been carried out while executing the anticipated responses, after the transition period has been concluded.

The next phase according to the present invention is the testing of the plan for the transition period. Usually during the “going live” stage some process design faults are found causing delays in the transition plan. Therefore, according to the present invention, the transition plan is tested and validated by going through live simulations, preferably while using a copy of the future to be used environment, enabling the testing to be simulated in the real environment at which the new application will eventually operate. All IT and business groups simulate full going live process preferably including all above elements to screen out the going live possible faults. Preferably, a copy of the production environment is used to simulate actual transition plan.

In addition, a company going through IT system replacement/business process change should preferably have a synchronized integrated plan that comprises the following:
business preparations—establish the business preparations that should be made in order to bridge the transition period;
establish IT activities that are required to complete the transition;
establish a transition testing plan in order to determine the way that transition plan be tested and verified; and
establish how will company resume its business activity once the going live phase has been completed.

### BRIEF DESCRIPTION OF THE DRAWINGS

FIG. 1—presents schematically the major steps in carrying out a process of changing software application/business model in accordance with an embodiment of the present invention.

### DETAILED DESCRIPTION OF THE INVENTION

A better understanding of the present invention may be obtained from the following non-limiting detailed description.

### EXAMPLE

Let us first consider the following example:

Company A has decided to install a new software application known as Enterprise Resource Planning (“ERP”). The company can undergo a similar process if it were to change one or more of its business processes. To do so, the method provided by the present invention has been carried out in accordance with the following steps:
(i) preparing a transition plan for execution during the transition period;
(ii) preparing contingency plans to allow for contingency responses in case of failures occurring during the execution of the transition plan and more importantly—contingency plans to allow appropriate responses to business events that might occur for the period where no system would be available. Companies which start the process of system replacement are exposed to unexpected business events. If such an event occurs and the company has not prepared adequate contingency plans, it might be required to stop the replacement process and to take a decision on how to handle the business event. This in turn might lead to a longer exposure period for the company, and sometimes even to business collapse due to the fact that the company's system has been non-operative for a too long period.
(iii) confirming readiness of at least part of the transition plan and the contingency plan; and
(iv) carrying out the transition plan.

The objectives set for the transition process were:

minimizing disturbances for customers, suppliers and employees and business partners;

involving customers, suppliers and business partners in the planning process; and

identifying critical business process milestones.

The integrated planning comprises the following:
business related preparations;
IT planning;
testing;
rehearsals;
following the “going live” phase—renewing business activities plan.

The objectives that were set for the transition plan and the contingency plans were:
Handling IT/process events;
Handling unexpected business events
Setting a business continuity plan for the case of a transition failure.

To achieve these objectives, the following was carried out:
A business continuity plan which took care of unexpected events that might cause delays in the transition process was prepared;
Emergency procedures for the darkness period (i.e. the period during which the company's systems or part of them are down) were prepared; and
A “go back to legacy (i.e. old operational systems)” plan was prepared.

The following objectives were set for the testing of the transition plan:
Minimizing “going live” process faults;
Preparing and training the users; and
Validating the transition plan.

Two full rehearsals were made in support of this phase.

For the last phase, the transition management, the objectives that were set were the following:
Confirming company readiness;
Supervising the execution of the transition plan;
Supervising the execution of the contingency plans as required; and
Controlling risk management.

To achieve these objectives the gating points set before execution of the transition plan were evaluated and the contingency plans were executed as required.

Let us now consider the steps included in preparation of the transition plan:
IT plan review—during which the IT going live plan has been identified as well as business areas that might be affected.
Possible business disturbances—during which business constrains in different business areas, were identified, as well as an optimal business preparation plan.
Cross business areas effect review—during which meetings were held with all business users from all business areas in order to identify mutual business implications across the company.
Obtaining company's management approval for business implications and preparations.
Reviewing IT solutions for the interim period—during which solutions needed for business activities during interim period were identified as well as it was determined how will these activities be reported in the new systems.
Adjusting business preparations to IT constrains.

The outcome of carrying out these steps was that the company agreed on business/IT plan for management approval, where this plan also comprised the testing plan and the designation of the responsible personnel.

Next, let us now consider the steps included in the contingencies plans:
Defining “going live” procedure with unexpected faults, while taking into account business implications and user readiness;
Preparing emergency procedures to enable the company to respond to unexpected business events during the transition period;
Identifying IT activities required for “go back to legacy” procedure, including indentifying the activities and preparing adequate procedures; and
Identifying business activities required for “go back to legacy” procedure, including indentifying the activities, preparing adequate procedures and assigning roles to users.

As a result of this phase, the company obtained an agreed upon emergency response that would allow it to react during the darkness period, and if the need arises, to revert to the legacy system.

Let us now consider the steps that were included in the testing plan for the transition:
Carrying out a first rehearsal and fault detection, which, as typically is the case, included a simulation of “going live” process which included process (business and IT) data verification, reviewing plan viability, including the users. Tolls and know-how;
Fault correction and preparing business adjustment, in which the users get to better understand the process and risks involved and consequently carry out process adjustment; and
Carrying out a second rehearsal on the adjusted process and analyzing the results, in which it is confirmed that the major faults have been eliminated and it can be recommended to start the “going live” process.
The completion of this phase meant that the business continuity plan were tested and confirmed.

The last phase was the managing of the transition which included the steps of:
Issuing a “going live” decision together with the company's management/board, after completing the business continuity plan and establishing the company's readiness to the transition;
Carrying out the “going live” process and retrieving conclusions therefrom. During the process controlling and solving unexpected events; and
Controlling business activities, evaluating the need for reverting to the legacy system by “going back to legacy”, and controlling the execution of the “going back to legacy” procedure if the need arises.

Typically, a business continuity plan is completed within 2 to 4 months following the start of the “going live” process.

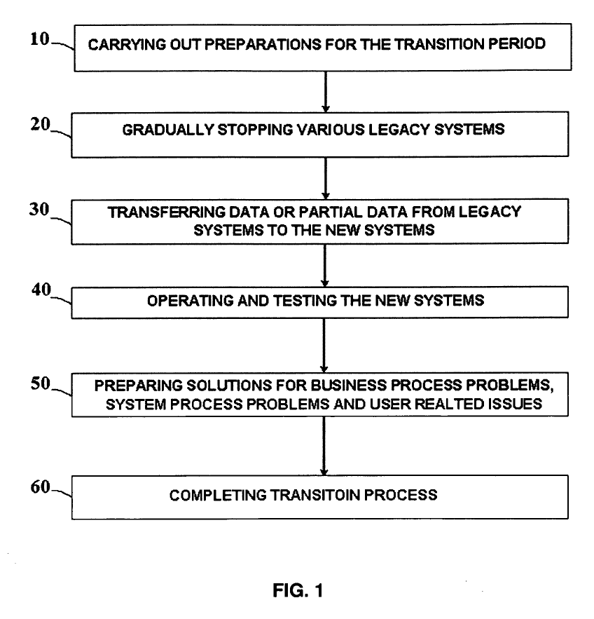

FIG. 1 describes in a schematic flow chart which comprises the major steps to be taken while carrying out a process of changing software application/business model. These steps are:
1. preparations (step 10);
2. gradually stopping legacy systems (step 20);
3. transferring data or part of the data from the legacy systems to the new systems (step 30);
4. operating and testing the new systems (step 40);
5. preparing solutions for business process problems found, system process problems and users' issues (step 50); and
6. completing transition (step 60).

One of the biggest concerns in this process is involved with steps 20 and 30 which form a “dark” stage in which the company capability to deal with arising problems without having good available tools to deal with such problems is rather limited. Such stage can theoretically last for 3 or more days for small companies (˜50 M$ company) but when considering actual constrains and unexpected issues it is more realistic to expect that this stage will last for 1 to 1.5 weeks. For medium/large size companies, this stage is expected to last about 3 weeks.

After completing step 30 small companies may typically reach about 50% of the operational efficiency which they used to have while operating their legacy system(s), i.e. before the transition plan took place, subject to appropriate training of the users and the preparations made.

As will be appreciated by those skilled in the art, the examples provided illustrate some ways of establishing a diagnostic protocol. However, similar methods may be used to achieve that goal, without departing from the scope of the present invention.

It is to be understood that the above description only includes some embodiments of the invention and serves for its illustration. Numerous other ways of carrying out the methods provided by the present invention may be devised by a person skilled in the art without departing from the scope of the invention, and are thus encompassed by the present invention.

1. A method for use by an organization for managing a transition period during which at least one software application is changed, said method comprises the steps of:
(i) providing a transition plan for execution during said transition period;
(ii) providing a contingency plan to allow for contingency responses in case of unexpected events occurring during the execution of said transition plan;
(iii) confirming readiness of at least part of said transition plan and said contingency plan; and
(iv) carrying out said transition plan.

2. A method according to claim 1, wherein the step of providing a transition plan and/or the step of providing a contingency plan comprises selecting one or more of objectives to be addressed by the corresponding plan from among a group consisting of:
a) minimization of business interruptions throughout said change;
b) minimization disruptions for customers, suppliers and employees;
c) participation of customers, suppliers and business partners at the preparations phase;
d) identifying critical organization's activities;
e) involving inner company's users;
f) making management aware of business risks;
g) minimizing “going live” process potential faults;
h) designating users' responsibilities;
i) validating said corresponding plan(s);
j) confirming company's preparations readiness;
k) supervising execution of said transition plan; and
l) controlling risk management.

3. A method according to claim 1, further comprising a step of identifying maximum critical possible business events that might occur during said transition period, and providing one or more responses to each such an event independent of current operational systems of said organization.

4. A method according to claim 1, further comprising a step of testing and validating said transition plan through going live simulations.

5. A method according to claim 1, wherein said transition plan further comprising a synchronized integrated plan which comprises the following:
establishing necessary business preparations to bridge said transition period;
establishing IT activities required to complete the transition;
determining a method for testing and validating said transition plan; and
establishing how will said organization resume its business activity once said transition plan has been successfully executed.
